(19) United States
(12) Patent Application Publication
(10) Pub. No.: US 2024/0302529 A1
(43) Pub. Date: Sep. 12, 2024

(54) METHOD FOR ESTIMATING THE SPEED OF A VEHICLE

(71) Applicant: Continental Autonomous Mobility Germany GmbH, Ingolstadt (DE)

(72) Inventors: Ludovic HUSSONNOIS, Saubens (FR); Niklas PETTERSSON, Toulouse (FR)

(21) Appl. No.: 18/444,984

(22) Filed: Feb. 19, 2024

(30) Foreign Application Priority Data
Mar. 8, 2023 (FR) 2302145

(51) Int. Cl. G01S 17/58; G01S 17/89

(52) U.S. Cl. CPC G01S 17/58; G01S 17/89

(57) ABSTRACT

A method for estimating the speed of a vehicle, including a scanning lidar sensor acquiring a point cloud, each point associated with an initial three-dimensional position, a time stamp, and an azimuth and elevation orientation of the line of sight of the lidar sensor. The computer processing the point cloud, including: detecting at least one object represented by a subset of points of the point cloud; determining a corrected position of a plurality of points of the object corresponding to the same azimuth or elevation value of the line of sight of the lidar sensor, the corrected positions of the plurality of points being aligned in a reference direction; and determining a relative speed between the ego-vehicle and the object, based on a difference between a corrected position and an initial position of at least one point of the object, and based on the time stamp associated with the point.

### CROSS REFERENCE TO RELATED APPLICATION

This application claims priority to French Patent Application 2302145, filed Mar. 8, 2023, the contents of such application being incorporated by reference herein.

### FIELD OF THE INVENTION

The present disclosure relates to a method for estimating the speed of a vehicle. It notably applies to estimating the speed of vehicles adjacent to a vehicle of interest, for implementing driving assistance functionalities in the vehicle of interest.

### BACKGROUND OF THE INVENTION

For many years, vehicles have been incorporating various kinds of sensors, such as cameras or lidar sensors, in order to obtain information concerning the environment of the vehicle. The data acquired by the sensors is processed by algorithms that allow the scene around the vehicle to be analyzed, notably in order to be able to detect obstacles on the road, to detect and track other vehicles, and also to anticipate their trajectory.

These various processes can be used to assist the driver in driving the vehicle, or ultimately even to replace the driver.

Within this context, several methods have already been proposed for estimating the speed of other vehicles located in the environment of a vehicle of interest, hereafter called ego-vehicle, using a lidar-type sensor. Hereafter, the ego-vehicle is the reference vehicle comprising the one or more sensors for observing the environment and in which processes for analyzing the environment of this vehicle are implemented.

For example, J. Zhang, W. Xiao, B. Coifman and J. P. Mills, in the document entitled, “Vehicle Tracking and Speed Estimation From Roadside Lidar”, in IEEE Journal of Selected Topics in Applied Earth Observations and Remote Sensing, volume 13, pages 5597-5608, 2020, doi: 10.1109/JSTARS.2020.3024921, incorporated herein by reference, describe a method for tracking and estimating the speed of vehicles based on several successive acquisitions by a lidar sensor.

W. Zang et al., in the document entitled “Lidar with Velocity: Correcting Moving Objects Point Cloud Distortion from Oscillating Scanning Lidars by Fusion with Camera”, arXiv:2111.09497v3 [cs.RO]; 2022, incorporated herein by reference, also describe a method combining acquisitions from a scanning lidar sensor and from a camera in order to estimate the speed of an observed vehicle, in which the radial speed of a vehicle is obtained based on the acquisitions of the lidar sensor, and the tangential speed is jointly estimated based on the data from the lidar sensor and the camera.

### SUMMARY OF THE INVENTION

The present disclosure is intended to improve the situation. In particular, an aspect of the present disclosure is to allow the speed of a vehicle to be estimated based on a single acquisition of a lidar sensor.

In this respect, a method is proposed for estimating the speed of a vehicle, the method being implemented by a device comprising a lidar sensor installed in an ego-vehicle, and a computer, the lidar sensor being of the scanning type in which an observed zone is acquired by moving the line of sight of the lidar sensor in two directions of movement comprising an azimuth scanning direction and an elevation scanning direction so as to cover the observed zone along a plurality of scanning lines, the method comprising the lidar sensor acquiring a point cloud where each point is associated with an initial three-dimensional position, a time stamp and an azimuth and elevation orientation of the line of sight of the lidar sensor, and the computer processing the point cloud, comprising:
detecting at least one object, the object being represented by a subset of points of the point cloud;
determining a corrected position of a plurality of points of the object corresponding to the same azimuth or elevation value of the line of sight of the lidar sensor, so that the corrected positions of the plurality of points are aligned in a reference direction; and
determining a relative speed between the ego-vehicle and the object, based on a difference between a corrected position and an initial position of at least one point of the object, and based on the time stamp associated with said point.

In some embodiments, the method comprises:
computing a relative speed of a plurality of points of the object based on a difference between the corrected position and the initial position of each point of the plurality of points, and based on the time stamp associated with said point; and
determining a relative speed between the ego-vehicle and the object based on the relative speeds computed for each point of the plurality of points.

In some embodiments, the detected object is identified as static, and the method comprises deducing the speed of the ego-vehicle based on the determined relative speed between the ego-vehicle and the object.

In some embodiments, the detected object is a vehicle, the speed of the ego-vehicle is known, and the method comprises deducing the speed of the detected object based on the determined relative speed between the ego-vehicle and the object.

In some embodiments, the method comprises determining a corrected position of a plurality of points of the object corresponding to the same elevation value of the line of sight of the lidar sensor, so that the corrected positions of the plurality of points are aligned in a direction perpendicular to the longitudinal direction of the ego-vehicle and parallel to the road.

In some embodiments, the method further comprises classifying the detected object as a function of the height of the object from among two predetermined classes respectively corresponding to high objects and low objects. In this case, when the object is classified as a low object, determining a corrected position of a plurality of points of the object is implemented for points of the object corresponding to the same elevation value of the line of sight of the lidar sensor, so that the corrected positions of the plurality of points are aligned in a direction perpendicular to the longitudinal direction of the ego-vehicle and parallel to the road.

When the object is classified as a high object, the method comprises determining a corrected position of a plurality of points of the object corresponding to the same azimuth value of the line of sight of the lidar sensor, so that the corrected positions of the plurality of points are aligned in a direction perpendicular to the longitudinal direction of the ego-vehicle and perpendicular to the road.

In some embodiments, detecting an object comprises implementing a point clustering algorithm based on the Euclidean distance between the points.

According to another aspect, a device is described for estimating the speed of a vehicle, comprising a lidar sensor able to be installed in an ego-vehicle, and a computer, the lidar sensor being of the scanning type in which an observed zone is acquired by moving the line of sight of the sensor by azimuth and by elevation in order to scan the zone, characterized in that the device is configured to implement the method as described above.

According to another aspect, a computer program product is described comprising code instructions for implementing the method as described above, when this program is executed by a processor.

According to another aspect, a non-transitory computer-readable storage medium is described that stores a program for implementing the method as described above, when this program is executed by a computer.

The proposed method allows the speed of an observed vehicle, or of the ego-vehicle integrating the lidar sensor, to be estimated based on a single estimate of this sensor. By using a scanning lidar sensor, it is possible to exploit the fact that the point cloud acquired during the same acquisition, i.e., the same scan, is acquired at different times, and that when the observed object has a relative speed with respect to the ego-vehicle, this relative speed induces a distortion between the positions of the points of the point cloud.

The relative speed between the ego-vehicle and the observed object can be deduced from this distortion.

### BRIEF DESCRIPTION OF THE DRAWINGS

Further features, details and advantages will become apparent from reading the following detailed description and from analyzing the appended drawings, in which:

FIG. 1 schematically shows an example of a context in which the method according to one embodiment is implemented;

FIG. 2 schematically illustrates the operating principle of a scanning lidar sensor;

FIG. 3 schematically shows the main steps of a method according to one embodiment;

FIG. 4 shows a top view of an example of the acquisition of a scanning lidar sensor comprising an object with the same speed as the ego-vehicle and an object with a lower speed than that of the ego-vehicle;

FIG. 5 shows a side view of an example of the acquisition of a scanning lidar sensor comprising an object with a speed greater than that of the ego-vehicle.

### DETAILED DESCRIPTION OF THE PREFERRED EMBODIMENTS

A method for estimating the speed of a vehicle will now be described according to some embodiments. This method can be implemented in order to estimate the speed of vehicles located in the environment of a reference vehicle V, also called ego-vehicle, or to estimate the speed of the ego-vehicle.

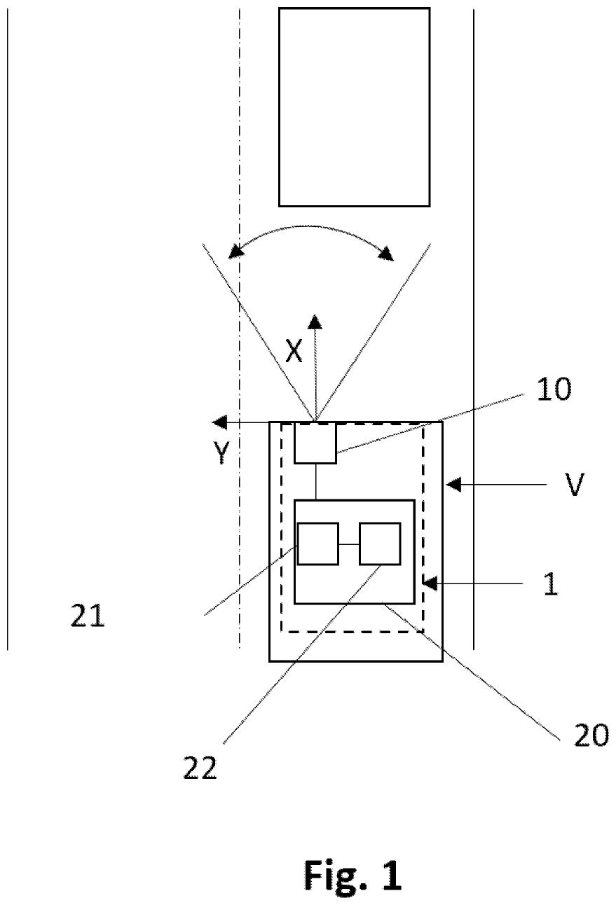

With reference to FIG. 1, the method is implemented by a device 1 comprising a lidar sensor 10 installed in the ego-vehicle V, and a processing unit 20 comprising at least one computer 21 and a memory 22. The computer can comprise one or more processors, microprocessors, microcontrollers, graphics processors, etc. Advantageously, the memory 22 comprises a non-volatile memory for storing code instructions that are executed by the computer in order to implement the method. The processing unit 20 can be installed in the ego-vehicle and connected to the sensor via a wired link, or it can be a remote unit adapted to receive the data acquired by the sensor by means of a wireless communications network.

The lidar sensor can be positioned at a front end of the ego-vehicle, oriented toward the front of the vehicle, advantageously in a direction parallel to the main direction of the vehicle. Alternatively, the lidar sensor can be positioned at a rear end of the ego-vehicle, oriented toward the rear of the vehicle, advantageously in a direction parallel to the main direction of the vehicle.

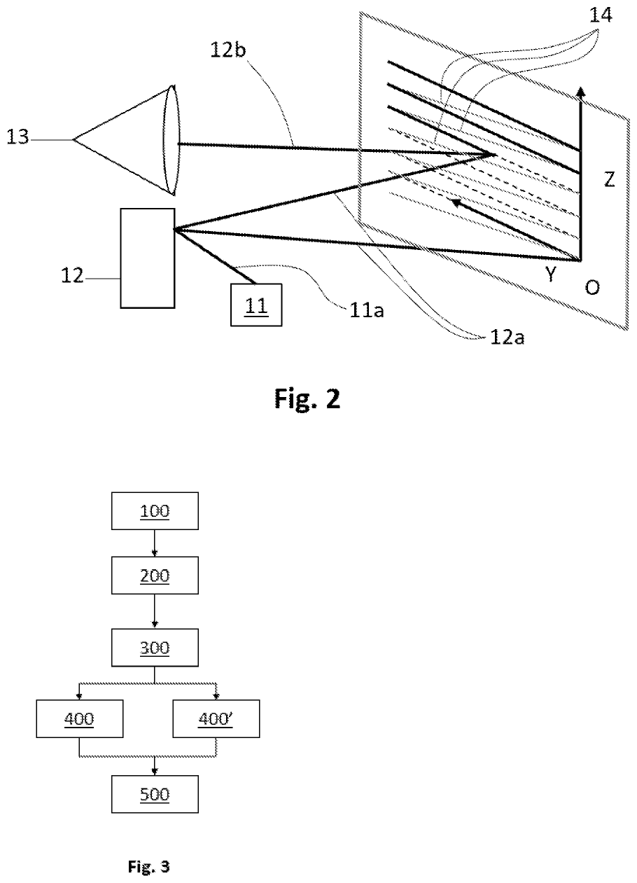

With reference to FIG. 2, the lidar sensor 10 is of the scanning type, for example of the microelectromechanical systems (MEMS) type, which is configured to move the line of sight of the sensor in two different directions of movement in order to scan the observed zone. A scanning lidar sensor 10 can thus comprise a light source 11, for example a laser, generating light pulses 11a at a determined frequency, a scanning device 12 comprising a movable mirror adapted to reflect the light emitted by the source in accordance with a variable orientation in order to obtain the desired orientation for the line of sight 12a, and a detector 13 adapted to receive the light reflected 12b by the objects present in the observed scene. The movement of the scanning device is synchronized with the emissions of the light pulses so that each light pulse corresponds to a respective orientation of the line of sight.

Hereafter, the reference orientation of the lidar sensor is considered to be that of the line of sight of the sensor when the first light pulse of an acquisition is emitted. The term “acquisition” (or “frame”) refers to the acquisition of a point cloud corresponding to a complete scan of the scene observed by the lidar sensor, whereupon the line of sight returns to the reference orientation in order to implement the next acquisition. The aforementioned orientation of the lidar sensor with respect to the vehicle therefore corresponds to the reference orientation.

In FIG. 2, the Y and Z axes represent the two scanning directions of the line of sight. The Y axis advantageously corresponds to a horizontal axis, and the Z axis advantageously corresponds to a vertical axis, when the lidar sensor is installed in the ego-vehicle. The movement of the line of sight along the Y axis corresponds to a variation in azimuth with respect to the reference orientation, denoted O in the figure, and the movement along the Z axis corresponds to a variation in elevation with respect to the reference orientation.

As is schematically shown in FIG. 2, scanning can be implemented by causing the line of sight to travel along several successive parallel horizontal or vertical lines 14, with a horizontal line being an iso-elevation line and a vertical line being an iso-azimuth line. In some embodiments, once a scanning line has been traversed, for example in terms of iso-elevation, the line of sight can be returned to the azimuth corresponding to the reference orientation before traversing the next line at a different elevation, and so on. As an alternative embodiment, scanning can include a scanning line by azimuth or elevation, and then, instead of returning to the azimuth, respectively to the elevation of the reference orientation, can include changing the elevation, respectively the azimuth, and scanning in the opposite direction by azimuth, respectively by elevation, in order to return to the azimuth, respectively to the elevation, of the reference orientation.

The lidar sensor is adapted to implement at least one acquisition per second, for example ten acquisitions per second, where each acquisition corresponds to a point cloud and each point is associated with a respective orientation of the line of sight of the sensor, with a time stamp that corresponds to the respective emission time of the light pulse corresponding to the point, and with three-dimensional coordinates that correspond to the spatial coordinates of a point on a surface on which the light pulse was reflected before being picked up by the detector of the lidar sensor.

As described hereafter, the described method allows the speed of an observed vehicle to be estimated knowing the speed of the ego-vehicle, or as a variant of the ego-vehicle, based on a single acquisition, i.e., a point cloud obtained by a single scan of the scene.

With reference to FIG. 3, the method comprises the lidar sensor 10 acquiring 100 a point cloud, with each point of the point cloud indicating the position of an object in the environment of the ego-vehicle on which the light pulse emitted by the lidar sensor has been reflected. Each point is associated with a respective time stamp corresponding to the emission time of the light pulse, three-dimensional coordinates, hereafter referred to as “point position”, and a respective orientation of the line of sight of the sensor, expressed, for example, by azimuth and elevation with respect to the reference orientation. This data is transmitted to the computer, which implements the following steps.

The method then comprises a step 200 of detecting at least one object located in the environment of the ego-vehicle, with the object being shown by a subset of points of the point cloud. This step advantageously comprises implementing a point clustering algorithm based on the Euclidean distance between the points of the point cloud, for example a k-means type algorithm.

In some embodiments, and as shown in FIG. 3, the method can then comprise a step 300 of classifying the detected object as a function of the height of the object, with the height of the object being obtained by measuring the maximum difference observed along the Z axis between two points of the subset corresponding to the object. If the height is less than a pre-established threshold, the detected object is considered to be a “low” type object, for example a car, and if the height is greater than this threshold, the detected object is considered to be a “high” type object, for example a bus, a truck, etc.

The method then comprises a step 400 of determining a corrected position of a plurality of points of the object, with respect to the initial position of these points. The plurality of points whose position is corrected advantageously corresponds to a set of points obtained for the same azimuth value, but different elevations, or the same elevation value, but different azimuths, of the line of sight of the lidar sensor.

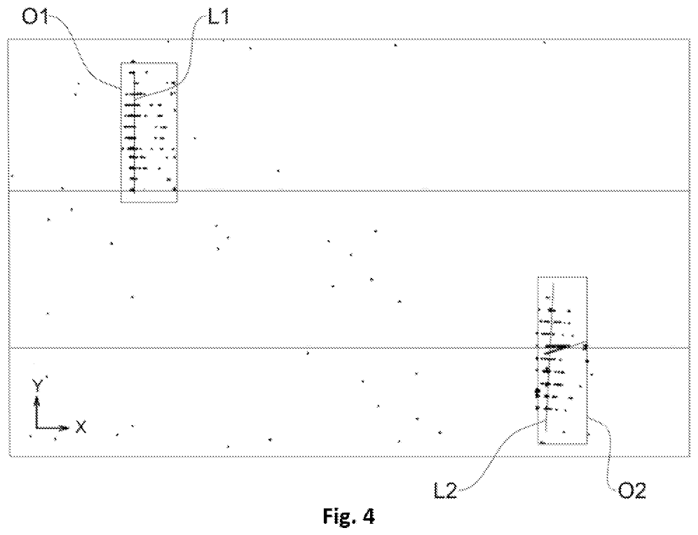

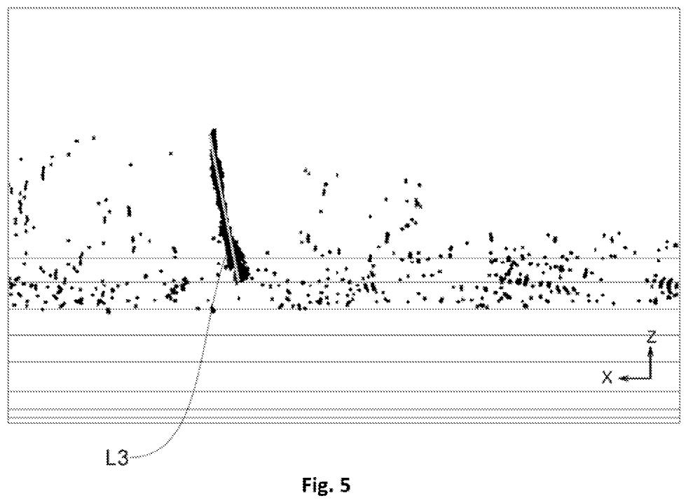

With reference to FIG. 4, an example of a point cloud obtained by a lidar sensor is shown as a top view, i.e., the representation is provided in an X-Y plane, where X is the main direction of the vehicle, preferably corresponding to the reference orientation of the lidar, and Y is a perpendicular corresponding to a scanning direction (azimuth scanning). Consequently, the Z coordinate of the points of the point cloud is not shown in the image.

FIG. 4 shows a first detected object O1, with this object having the same speed as the ego-vehicle. Given this identical speed, the points belonging to this object and corresponding to different azimuths of the line of sight of the lidar appear with the same Y coordinate value, i.e., all the points acquired for the same elevation of the line of sight but with different azimuth values are aligned horizontally (in FIG. 4, the points corresponding to a scan of the line of sight in terms of iso-elevation have been connected together by a line L1 and it can be seen that this line forms a zero angle with the Y axis).

A second detected object O2 is shown, with this object having a lower speed than the ego-vehicle. Given the time interval between two consecutive points of the point cloud, it can be seen that points corresponding to different azimuths of the line of sight of the lidar are offset from one another in the Y direction. In FIG. 4, the points corresponding to a scan of the line of sight in terms of iso-elevation have been connected together by a line L2 and it can be seen that this line forms a non-zero angle with the Y axis.

Consequently, step 400 advantageously comprises correcting the position of the points obtained for the same elevation value, but therefore corresponding to different azimuths of the line of sight, so that the corrected positions of the points are aligned, and more specifically are aligned in a direction perpendicular to the longitudinal direction of the ego-vehicle, i.e., to the X axis, and parallel to the road locally considered to be a plane. The positions of the corrected points therefore all have the same coordinate along X. This corresponds, with the aforementioned reference orientation, to an alignment of the points parallel to the Y azimuth scanning direction of the sensor.

In one embodiment, step 400 can involve applying a principal component analysis type algorithm to the subset of points of the point cloud corresponding to an object, in order to extract the principal x, y and z directions along which the point cloud extends, followed by a rotation applied to the subset of points with respect to the first detected point of the subset in order to align the subset of points in the direction indicated above. This therefore involves an overall rotation that is estimated in order to align the set of points, which then corresponds to a correction applied to each point with respect to its distance with respect to the first detected point of the subset.

In some embodiments, in particular in cases where the lidar sensor is positioned at the front of the vehicle and therefore allows data to be acquired that relates to the rear of surrounding vehicles, it is possible to check, after correction, that the corrected point cloud has a concave envelope, which is the case for the rear of the vehicles. If this aspect is not checked, the process stops without deducing the relative speed between the detected object and the ego-vehicle, and resumes with a subsequent acquisition of the point cloud.

When the method does not comprise a step 300 of classifying the object as a function of its height, this step 400 can be implemented for all vehicles.

However, when the method comprises a step 300 of classifying the object as a function of its height, this implementation of step 400 advantageously only relates to low vehicles. High vehicles can then undergo another correction, which is more accurate given the height of the vehicle.

With reference to FIG. 5, another example of a point cloud obtained by a lidar sensor is shown as a side view, i.e., the representation is provided in an X-Z plane, where X is the main direction of the vehicle, preferably corresponding to the reference orientation of the lidar, and where Z is a perpendicular corresponding to a scanning direction (elevation scan). Consequently, the Y coordinate of the points of the point cloud is not shown on the image.

FIG. 5 shows a point cloud including a detected object with a speed that is greater than that of the ego-vehicle. If the object had a speed identical to that of the ego-vehicle, the points belonging to this object and corresponding to different elevations of the line of sight of the lidar would appear with the same X coordinate value, i.e., all the points acquired for the same azimuth of the line of sight but with different elevation values would be aligned vertically, parallel to the z axis. However, in the case shown, which corresponds to a scan from top to bottom, the time interval between the acquisition of the points corresponding to the highest values of Z and the points corresponding to the lowest values of Z results in a shift along X of the positions of the points, and therefore a line L3 connecting points corresponding to the same azimuth of the line of sight that is inclined with respect to Z.

In this case, step 400′ comprises correcting the positions of the points obtained for the same azimuth value, but corresponding to different elevations of the line of sight, so that the corrected positions of the points are aligned in a direction perpendicular to the longitudinal direction of the ego-vehicle, i.e., to the X axis, and perpendicular to the road that is locally considered to be a plane, i.e., a substantially vertical direction when the road is horizontal. The positions of the corrected points therefore all have the same X coordinate. This corresponds, with the aforementioned reference orientation, to an alignment of the points parallel to the Z direction for elevation scanning of the lidar sensor.

In one embodiment, step 400′ can comprise applying a principal component analysis type algorithm to the subset of points of the point cloud corresponding to an object, in order to extract the principal x, y and z directions along which the point cloud extends, followed by a rotation applied to the subset of points with respect to the first detected point of the subset in order to align the subset of points in the direction indicated above. This therefore involves an overall rotation that is estimated in order to align the set of points, which then corresponds to a correction applied to each point with respect to its distance with respect to the first detected point of the subset. Based on the corrected positions of at least some points belonging to the object, the method comprises a step 500 of determining a relative speed between the ego-vehicle and the object. This step is implemented based on a difference between the corrected position of a point and the initial position of the point, and of the time stamp associated with said point.

More specifically, the relative speed can be computed as follows:

$${ν}_{p} = \frac{{p}_{i} - {p}_{c o r}}{{t}_{p} - {t}_{r e f}}$$

Where Vₚ is the relative speed computed for point p, pₗ is the initial position of point p, p_{cor} is the corrected position of point p, tₚ is the time stamp associated with point p and t_{ref} is a reference time, which is selected as the time stamp of the first point of a scanning line.

The relative speed is advantageously computed for several points belonging to the object and whose positions are corrected, and the method comprises deducing the relative speed between the ego-vehicle and the object based on speeds computed for the various points, for example by an average of the computed speeds.

In the event that the detected object is a moving object, and if the speed of the ego-vehicle is otherwise known, the method allows the absolute speed of the moving object to be deduced. Alternatively, if the detected object is a static object, for example a signaling element, the method allows the speed of the ego-vehicle to be deduced.

1. A method for estimating the speed of a vehicle, the method being implemented by a device comprising a lidar sensor installed in an ego-vehicle, and a computer, the lidar sensor being of the scanning type in which an observed zone is acquired by moving a line of sight of the lidar sensor in two directions of movement comprising an azimuth scanning direction and an elevation scanning direction so as to cover the observed zone along a plurality of scanning lines,
the method comprising the lidar sensor acquiring a point cloud where each point is associated with an initial three-dimensional position, a time stamp and an azimuth and an elevation orientation of the line of sight of the lidar sensor, and the computer processing the point cloud, comprising:
detecting at least one object, the object being represented by a subset of points of the point cloud;
determining a corrected position of a plurality of points of the object corresponding to a same azimuth or a same elevation value of the line of sight of the lidar sensor, so that the corrected positions of the plurality of points are aligned in a reference direction; and
determining a relative speed between the ego-vehicle and the object, based on a difference between a corrected position and an initial position of at least one point of the object, and based on the time stamp associated with said point.

2. The method as claimed in claim 1, further comprising:
computing a relative speed of a plurality of points of the object based on a difference between the corrected position and the initial position of each point of the plurality of points, and based on the time stamp associated with said point; and
determining a relative speed between the ego-vehicle and the object based on the computed relative speeds for each point of the plurality of points.

3. The method as claimed in claim 1, wherein the detected object is identified as static, and the method further comprises deducing the speed of the ego-vehicle based on the determined relative speed between the ego-vehicle and the object.

4. The method as claimed in claim 1, wherein the detected object is a vehicle, the speed of the ego-vehicle is known, and the method further comprises deducing the speed of the detected object based on the determined relative speed between the ego-vehicle and the object.

5. The method as claimed in claim 1, comprising determining a corrected position of a plurality of points of the object corresponding to the same elevation value of the line of sight of the lidar sensor, so that the corrected positions of the plurality of points are aligned in a direction perpendicular to the longitudinal direction of the ego-vehicle and parallel to the road.

6. The method as claimed in claim 1, further comprising classifying the detected object as a function of a height of the object from among two predetermined classes respectively corresponding to high objects and low objects.

7. The method as claimed in claim 5, wherein determining the corrected position of a plurality of points of the object is implemented by classifying the detected object as a function of a height of the object from among two predetermined classes respectively corresponding to high objects and low objects when the object is classified as a low object.

8. The method as claimed in claim 6, further comprising, when the object is classified as a high object, determining a corrected position of a plurality of points of the object corresponding to the same azimuth value of the line of sight of the lidar sensor, so that the corrected positions of the plurality of points are aligned in a direction perpendicular to the longitudinal direction of the ego-vehicle and perpendicular to the road.

9. The method as claimed in claim 1, wherein detecting an object comprises implementing a point clustering algorithm based on the Euclidean distance between the points.

10. A device for estimating the speed of a vehicle, comprising a lidar sensor able to be installed in an ego-vehicle, and a computer, the lidar sensor being of the scanning type in which an observed zone is acquired by moving the line of sight of the sensor by azimuth and by elevation in order to scan the zone, wherein the device is configured to implement the method as claimed in claim 1.

11. A non-transitory computer program product comprising code instructions for implementing the method as claimed in claim 1 when the program is executed by a computer.

12. The method as claimed in claim 2, wherein the detected object is identified as static, and the method further comprises deducing the speed of the ego-vehicle based on the determined relative speed between the ego-vehicle and the object.

13. The method as claimed in claim 2, wherein the detected object is a vehicle, the speed of the ego-vehicle is known, and the method further comprises deducing the speed of the detected object based on the determined relative speed between the ego-vehicle and the object.
